(19) United States
(12) Patent Application Publication
(10) Pub. No.: US 2026/0125244 A1
(43) Pub. Date: May 7, 2026

(54) TECHNIQUES FOR DISPLACEMENT OF AN ELECTROLYTIC VESSEL

(71) Applicant: PULTRUSION TECHNIQUE INC., Saint-Bruno-de-Montarville (CA)

(72) Inventor: Robert Dufresne, Saint-Bruno-de-Montarville (CA)

(73) Assignee: PULTRUSION TECHNIQUE INC., Saint-Bruno-de-Montarville, QC (CA)

(21) Appl. No.: 19/117,292

(22) PCT Filed: Oct. 6, 2023
(86) PCT No.: PCT/CA2023/051331

§ 371 Date: Mar. 31, 2025

Related U.S. Application Data
(60) Provisional application No. 63/378,747, filed on Oct. 7, 2022.

(51) Int. Cl. B66C 1/10; B66C 1/12; C25C 7/06

(52) U.S. Cl. CPC B66C 1/101; C25C 7/06; B66C 1/127

(57) ABSTRACT

An anchor system is proposed for securing to an electrolytic vessel to render the electrolytic vessel liftable upon coupling with the lifting device. The anchor system includes a plurality of strap assemblies being secured to respective anchor sections of the vessel and each strap assembly includes a strap and at least one anchor configured to provide anchorage to a lifting accessory of the lifting device. The system can further include at least one additional strengthener that can be positioned onto respective lower strap sections of the straps, or along an inner or outer surface of a base core wall of a core of the electrolytic vessel. A lifting system including the anchor system and the lifting device, liftable assembly including the anchor system and the electrolytic vessel, and a method for lifting and displacing the electrolytic vessel are further provided.

### TECHNICAL FIELD

The present technology relates to lifting techniques for an electrolytic vessel, and more particularly to the use of anchor assemblies and related lifting equipment to perform such lifting and further displacement.

### BACKGROUND

Electrolytic vessels for hydrometallurgical refining of metals are conventionally provided adjacent to one another, often in side-to-side relation. Adjacent cells may be glued to each other to form a single row of cells. The size, materials and configuration of adjacent electrolytic vessels, render the maintenance or replacement of a vessel an arduous operation.

An electrolytic vessel is usually lifted for such operation, thereby submitting the vessel to dynamic loads which can lead to damaging and cracking the electrolytic cavity of the vessel, usually made of concrete. When an electrolytic vessel has to be replaced, maintained or cleaned, there may be also insufficient space in between adjacent electrolytic vessels to pass the desired cables, straps, slings, curtains or other equipment.

There is a number of challenges related to handling electrolytic cells that are located or positioned in close proximity to each other or with respect to walls or other hindrances.

### SUMMARY

In some implementations, there is provided an anchor system for allowing an electrolytic vessel having a core shaped to hold an electrolytic liquid to be lifted by a lifting device, the anchor system comprising:

a plurality of straps comprising at least two straps being secured to respective surfaces of at least two opposed core walls of the core of the electrolytic vessel, each strap of the plurality of straps comprising:
a lower strap section coupled to the surface of the core wall; and
an upper strap section extending above the core; and

a plurality of anchors comprising at least two anchors configured to provide anchorage to a lifting accessory of the lifting device, each anchor of the plurality of anchors being connected to the upper strap section of the respective straps.

In some implementations, the lower strap sections of the plurality of straps are coupled to an inner surface of the respective opposed core walls. In some implementations, the lower strap sections of the plurality of straps are coupled to an outer surface of the respective opposed core walls. In some implementations, a portion of the plurality of straps is coupled to an inner surface of the respective opposed core walls and another portion of the plurality of straps is coupled to an outer surface of the respective opposed core walls. In some implementations, the plurality of straps comprises four straps, with two straps being coupled to each of two opposed core walls of the core of the electrolytic vessel. In some implementations, the plurality of straps comprises four pairs of adjacent straps, with two pairs of adjacent straps being coupled to each of two opposed core walls of the core of the electrolytic vessel. In some implementations, the system also includes a layer of chemical fixation securing each one of the plurality of straps to the surface of the respective opposed core walls. In some implementations, the straps are coupled to opposed end core walls. In some implementations, the straps are coupled to opposed lateral side core walls. In some implementations, the layer of chemical fixation comprises an adhesive sub-layer. In some implementations, the plurality of straps can comprise at least eight straps in total. In some implementations, the adhesive sub-layer comprises an epoxy resin. In some implementations, the layer of chemical fixation comprises another sub-layer of adherent primer between the respective lower strap sections and the adhesive sub-layer. In some implementations, the adherent primer comprises silane, siloxane or a combination thereof. In some implementations, each anchor comprises a main component connected to respective upper strap sections of the straps and a connector connected to the lifting accessory of the lifting device. In some implementations, each anchor is a D-hook, a C-hook, D-hook 90°, T-hook. In some implementations, the system includes a plurality of overlay battens comprising at least two overlay battens being secured to respective opposed core walls and covering at least a portion of respective lower strap sections in a transverse direction with respect to a direction of the straps. In some implementations, the overlay battens are chemically fixed to the respective straps and/or core walls. In some implementations, each overlay batten is secured to a portion of an outer side surface of the lower strap section of the respective straps and a corresponding portion of the respective core walls via chemical fixation. In some implementations, each overlay batten is sized to extend over and across at least two lower strap sections of adjacent straps. In some implementations, the system includes a plurality underlay batten segments being secured to the respective core walls, the underlay batten being positioned below at least one overlay batten and in alignment with the overlay batten, with the at least one overlay batten being secured to the respective underlay batten segments. In some implementations, the system has at least one additional strengthener being positioned onto respective lower strap sections of the straps. In some implementations, the at least one additional strengthener comprises a plurality of vertical strengtheners extending over the lower strap section of the respective straps and being secured to at least one of the respective core walls or the lower strap sections. In some implementations, each vertical strengthener is chemically fixed and/or mechanically fixed to at least one of the respective core walls or lower strap sections. In some implementations, the at least one additional strengthener comprises a connector component for joining two adjacent straps, the connector component defining a structure having four corners and each corner being secured to corresponding portions of respective lower strap sections of the two adjacent straps. In some implementations, the at least one additional strengthener comprises at least one outer strap that is securable to the lifting accessory of the lifting device, and that is positioned to surround an outer surface of the core of the electrolytic vessel. In some implementations, the at least one additional strengthener comprises an elongated strengthening base that is held below the electrolytic vessel with the surrounding outer strap.

In another aspect, there is provided an anchor system for allowing an electrolytic vessel having a core shaped to hold an electrolytic liquid to be lifted by a lifting device, the anchor system comprising: a base that is secured to an inner surface of a base wall of the core, the base having a plurality of anchor sections, and each anchor section comprising an anchor; and a plurality of strap assemblies being secured to the respective anchor sections of the base, and each strap assembly comprising: a strap having a proximal end and a distal end, a proximal anchor configured to provide anchorage to a lifting accessory of the lifting device, and a distal anchor that is coupled to the anchor of the respective anchor sections of the base.

In another aspect, there is provided a lifting system for lifting an electrolytic vessel upon actuation of a lifting device, the electrolytic vessel comprising core shaped to hold an electrolytic liquid and which comprises a core base and four core walls extending upwardly from peripheral edges of the core base, the lifting system comprising: an anchor system as defined herein; and a lifting device coupled to the lifting accessory that is connectable to the anchor system and configured to lift the core via the anchor system. In some implementations, the system also has a net surrounding an outer surface of the electrolytic vessel to hold the electrolytic vessel during lifting thereof, with the net being securable to the lifting accessory.

In yet another aspect, there is provided a liftable assembly comprising: an electrolytic vessel for refining metals comprising a core defining a cavity to hold electrolytic liquid, the core comprising a core base for contacting a floor, and four core walls extending upwardly from peripheral edges of the core base; and an anchor system as defined herein, the anchor system being secured to the electrolytic vessel to render the electrolytic vessel liftable upon coupling with the lifting device.

In another aspect, there is provided a method for lifting and displacing an electrolytic vessel, the method comprising: securing an anchor system as defined herein to the core of the electrolytic vessel; securing the lifting accessory of the lifting device to the anchors of the anchor system; and activating the lifting device to lift the electrolytic vessel.

While the invention will be described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

FIG. 1 is a top perspective view of two adjacent rows of electrolytic vessels.

FIG. 2 is a top perspective view of an example of an electrolytic vessel coupled to an anchor system defining an assembly as exemplified herein.

FIG. 3 is a cross-sectional view of the assembly of FIG. 2.

FIG. 4 is a top perspective view of an example of an electrolytic vessel coupled to another anchor system defining an assembly as exemplified herein.

FIG. 5 is a close-up cross-sectional view of part of the assembly of FIG. 4.

FIG. 6 is a close-up side view of part of the cell of FIG. 4.

FIG. 7 is a top perspective view of another example of an electrolytic vessel coupled to another anchor system.

FIG. 8 is a top perspective view of another example of an electrolytic vessel coupled to yet another anchor system.

FIG. 9 is a top perspective view of another example of an electrolytic vessel that is coupled to another anchor system and also illustrating a lifting accessory connected to the anchor system for lifting the vessel.

FIG. 10 is a side cross-sectional view of the assembly of FIG. 9.

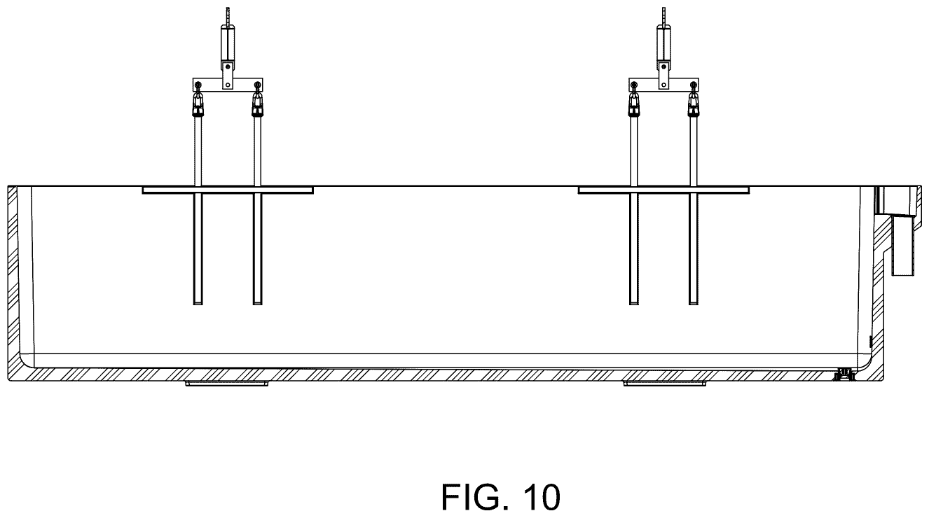

FIG. 11 is a close-up view of part of the cell of FIG. 10.

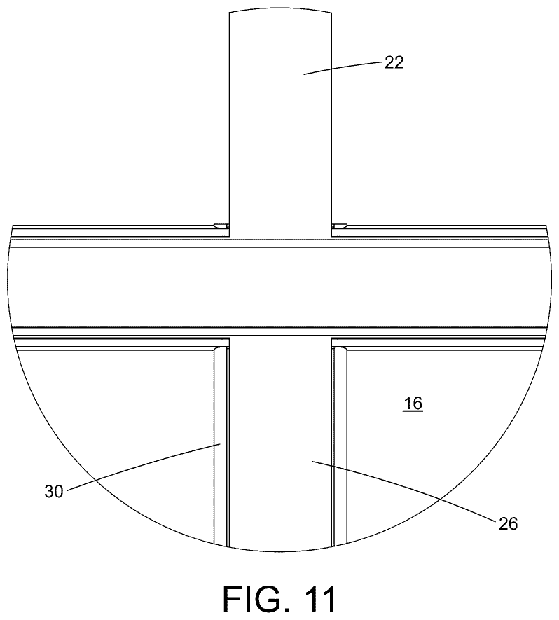

FIG. 12 is another cross-sectional view of the assembly of FIG. 9.

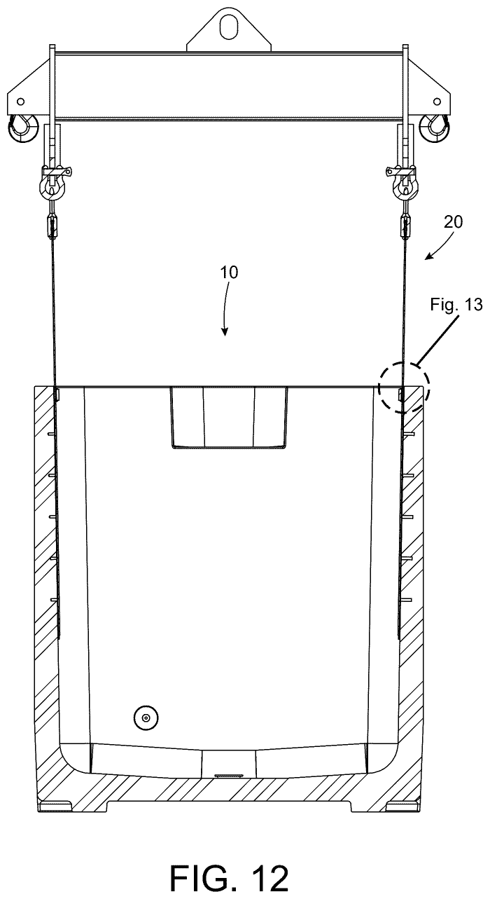

FIG. 13 is a close-up view of part of the cross-sectional view of FIG. 12.

FIG. 14 is another cross-sectional view of the assembly of FIG. 9.

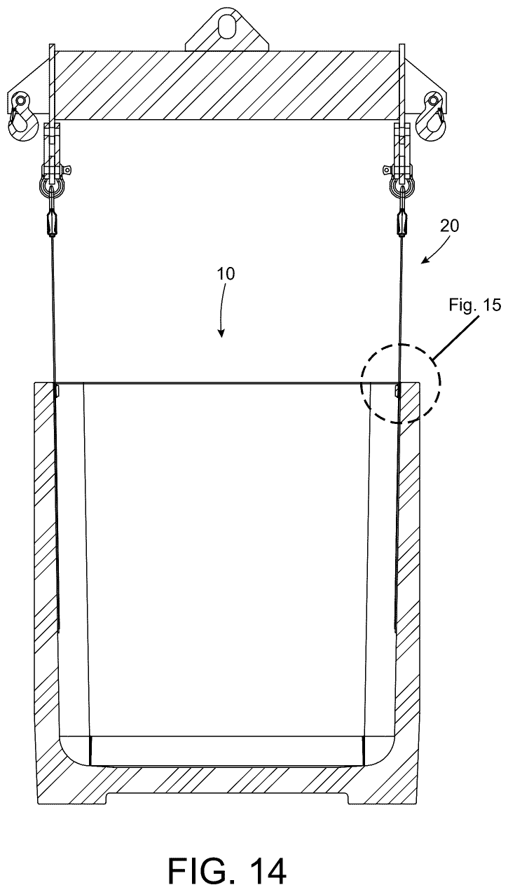

FIG. 15 is a close-up view of part of the cross-sectional view of FIG. 14.

FIG. 16 is a top perspective view of yet another example of an electrolytic vessel that is coupled to another anchor system and also illustrating part two lifting accessories.

FIG. 17 is a close-up view of a portion of the electrolytic vessel and anchor system of FIG. 16.

FIG. 18 is a close-up side cross-sectional view of the assembly of FIG. 17.

FIG. 19 is a top perspective view of an electrolytic vessel that is coupled to an anchor system including eight straps that are connected to two lifting accessories.

FIG. 20 is a close-up top perspective view of part of an anchor and lifting accessory of FIG. 19.

FIG. 21 is a top perspective view of an electrolytic vessel that is coupled to an anchor system including eight straps and two outer straps that are connected to two lifting accessories.

FIG. 22 is a close-up top perspective view of part of the anchor system and lifting accessory of FIG. 21.

FIG. 23 is a side view of an electrolytic vessel that is coupled to an anchor system including eight straps and four angled outer straps that are connected to two lifting accessories.

FIG. 24 is a top perspective view of a strengthening base.

FIG. 25 is a top perspective view of another strengthening base.

FIG. 26 is a top perspective view of yet another strengthening base.

FIG. 27 is a top perspective view of an electrolytic vessel that is coupled to an anchor system including four straps and two strengthening bases.

FIG. 28 is a cross-sectional view of the assembly of FIG. 27.

FIG. 29 is a side view cross-sectional view showing two pairs of adjacent straps being secured to a lateral side core wall with chemical fixation and strengthener comprising a vertical strengthener and a transverse batten including an overlay batten and underlay batten segments (not apparent).

FIG. 30 is top perspective view of an assembly including an electrolytic vessel and an anchor system including multiple strengtheners comprising a plurality of connector components between adjacent straps.

FIG. 31 is a close-up view of portion M of FIG. 30.

FIG. 32 is a front view of a connector component as shown in FIG. 30.

FIG. 33 is a top perspective view of an anchor system including a pair of straps securable to an electrolytic vessel and multiple strengtheners including battens and batten segments, vertical strengtheners and a cross-connector.

FIG. 34 is a cross-sectional side view along a strap of the anchor system of FIG. 33 showing a mechanical stop element to guide installation of the anchor system onto the electrolytic vessel.

FIG. 35 is a close-up view of portion J as shown in FIG. 34.

### DETAILED DESCRIPTION

The present description relates to techniques for lifting and displacing an electrolytic vessel for refining metals. More particularly, the present lifting and displacing techniques can be used for damaged electrolytic vessel that need to be repaired or replaced without having to disturb the refining operation for a long time and while offering a safety environment to the workers during lifting and displacement of the damaged vessel.

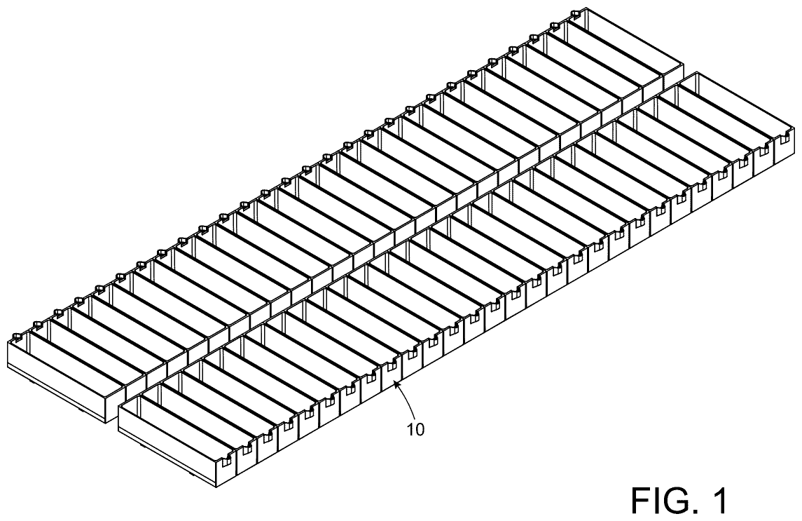

Referring to FIG. 1, the electrolytic vessels 10 are typically arranged in a plurality of rows with the electrolytic vessels 10 of each row being aligned with respect to one another and being positioned adjacent to one another. Each electrolytic vessel can include a core shaped to hold an electrolytic liquid, the core having a core base and four core walls extending upwardly from peripheral edges of the core base. For the purpose of operating lifting and displacement of at least one electrolytic vessel, the electrolytic vessel can be combined with an anchor system that is secured to the core. The anchor system includes a plurality of straps that include lower strap sections coupled to respective surfaces of opposed core walls and upper strap sections extending above the core. The anchor system also includes a plurality of anchors connected to respective upper strap sections, the anchors being configured to provide anchorage to a lifting accessory of a lifting device. The lifting device can thus be activated to pull upward on the straps which are secured to the core wall surfaces to enable the core to be raised and displaced. These techniques are notably useful for removing a damaged electrolytic vessel from the rows or network of electrolytic vessels. The securing of the anchor system to the core of the electrolytic vessel can be performed easily, quickly and safely from an upper environment of the installation, thereby preventing any operator from being exposed to leaks from the electrolytic liquid and electrical shocks.

The anchor systems described herein may be particularly suited for use in combination with lifting devices, such as an overhead crane or a dart mobile lifting crane as generally used in industrial facilities, which is equipped with a hoist and a lifting accessory. However, it is noted that parts of the anchor systems may be adapted to any lifting device able to lift an electrolytic vessel of industrial size.

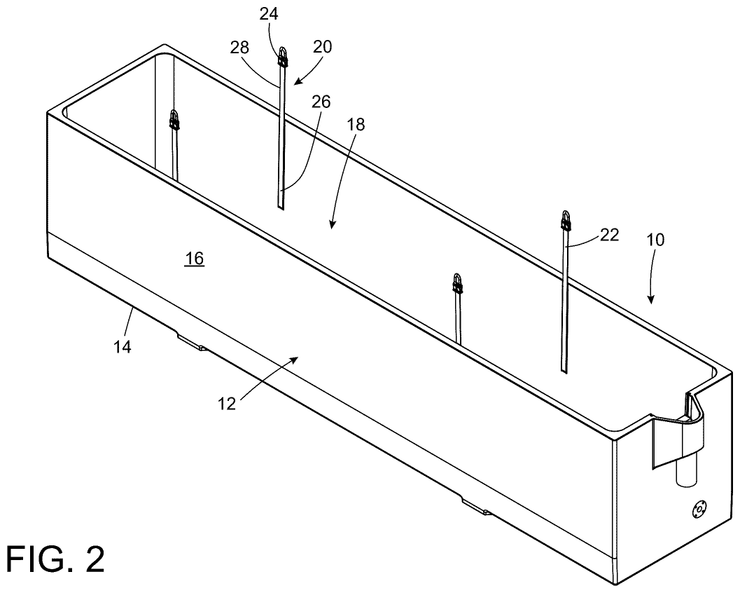

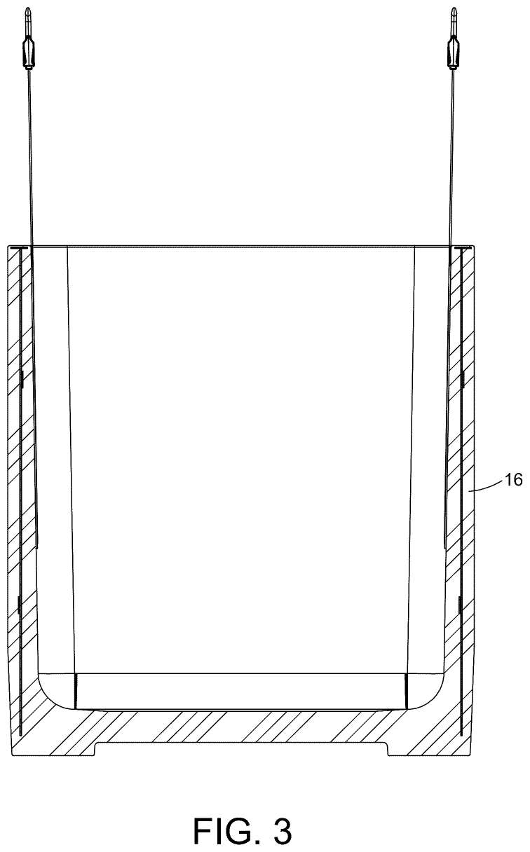

Referring now to FIG. 2, the electrolytic vessel 10 includes a core 12 that has a base 14 and four core walls 16 which together define a cavity 18 for accommodating an electrolytic liquid for metal refining. As better seen in FIG. 3, the core walls 16 can be generally vertical with a slight angle tapering outward in the upward direction. Referring to FIG. 2, the electrolytic vessel 10 is coupled with an anchor system 20 that includes multiple straps 22 and anchors 24. Each strap 22 includes a lower strap section 26 coupled to a surface of one of the core walls 16, and an upper strap section 28 extending out of the top of the core 12. The anchor 24 is secured at the end of the upper strap section 28.

More particularly, the electrolytic vessels as encompassed herein are electrolytic vessels that are encountered in electrolytic refining of metals such as copper, zinc, nickel and others. The core of the electrolytic vessel can be made of polymer concrete or prestressed polymer concrete. The electrolytic vessel can further comprise a fiberglass-based envelope surrounding the inner surface (substantially corresponding to the cavity receiving the electrolytic liquid) and the outer surface of the core. In some cases, the mechanical resistance of the vessel walls to internal and external stresses is further improved by the use of a multiple-layer fiberglass-based envelope surrounding the core of the vessel. The envelope can include at least one continuous fiberglass-based layer. Further optionally, the envelope can include multiple fiberglass-based layers. Further optionally, the fiberglass-based envelope can include multiple layers of at least one of fiberglass mat, knitted fiberglass, stitched, stitched-mat, knitted-mat and fiberglass woven roving. Optionally, the fiberglass-based envelope can include successive layers of fiberglass mat, knitted fiberglass, stitched, stitched-mat, knitted-mat and fiberglass woven roving. Optionally, the electrolytic vessel can be reinforced with a plurality of rebars embedded in at least two opposed walls of the core. Flat rebars can offer improved tensile strength when the core walls are subjected to internal and external stresses. The number and orientation of the embedded rebars may vary and can be adapted according to certain configurations and materials of the vessel. The rebars offer complementary strength during lifting when movements of the overhead crane can change the dynamic loads or generate vibrations. Optionally, the rebars can be made of pultruded fiberglass.

The present techniques can be particularly used to lift and displace damaged electrolytic vessels. The number and configuration of the anchor system that is coupled to the electrolytic vessel for its lifting and displacement are chosen to prevent the damaged electrolytic vessel from falling apart during lifting and displacement.

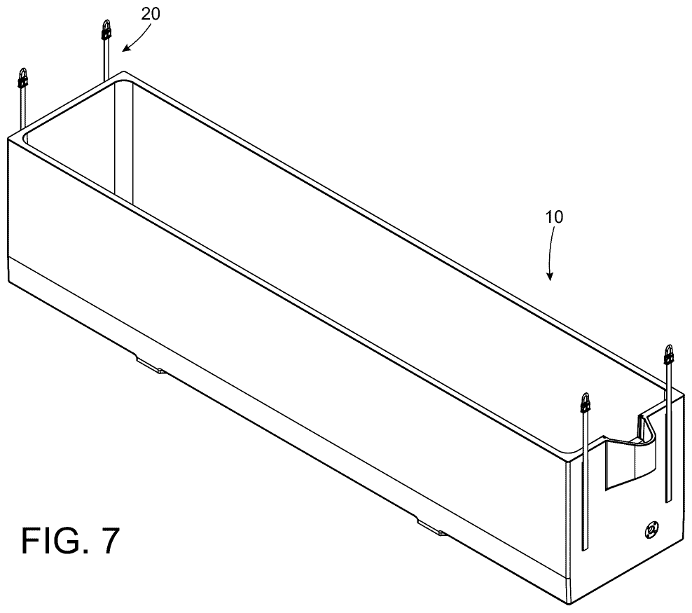

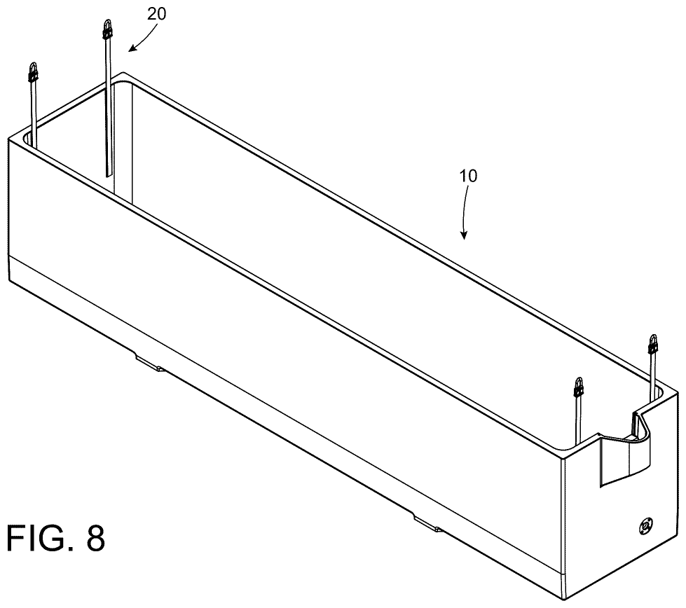

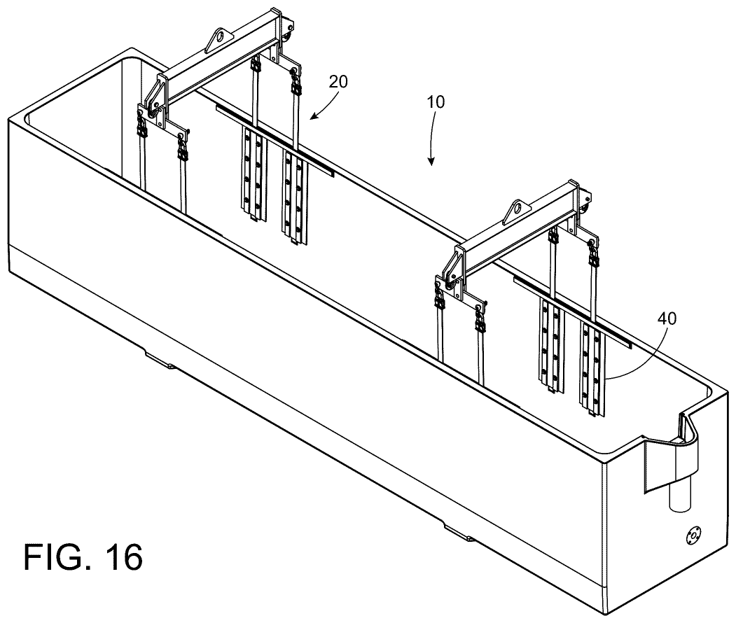

As shown in FIGS. 2, 4, 7, 8, 9, 16, 19, 21 and 23, for example, the anchor system can include multiple straps 22 coupled to the surfaces of the core walls 16. The straps 22 can be secured to the end walls (as in FIGS. 7 and 8) or the lateral side walls (as in FIGS. 2, 4, 16, 19, 21 and 23). The straps 22 can be secured to the inner surface of the core walls (as in FIGS. 2, 4, 8, 16, 19, 21 and 23) or to an outer surface of the core walls (as shown in FIG. 7). When the outer surface is used, it is preferred to be the end walls rather than the lateral side walls, since core are typically arranged in a close side-to-side configuration, as illustrated in FIG. 1 for example, such that side walls can be very close or even touch.

The number of straps can vary and be tailored to the desired distribution of mechanical constraints imposed to the vessel during lifting and displacement in accordance with the state of the vessel. Number and location of the components forming the anchor system within the core walls of the vessel may be chosen to account for applied loads which are expected during the lifting and displacement of the vessel, and especially according to the rigging configuration desired for the lifting phase. A person skilled in the art will readily understand that, to provide balance during lifting, at least one anchor system should be coupled with each of two opposed core walls of a vessel. It should further be noted that a symmetrical configuration for the distribution of the anchor systems should be privileged. It should further be noted that different implementations of the anchor system may be coupled with the core walls of the same vessel.

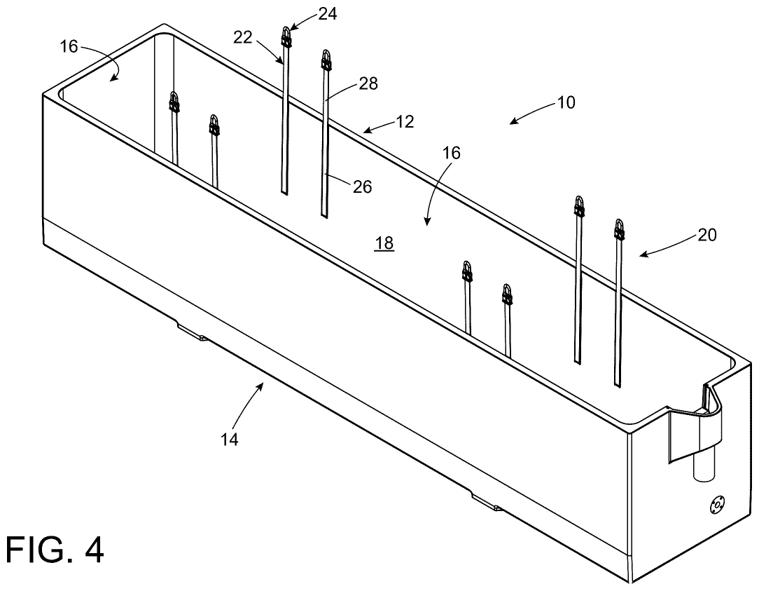

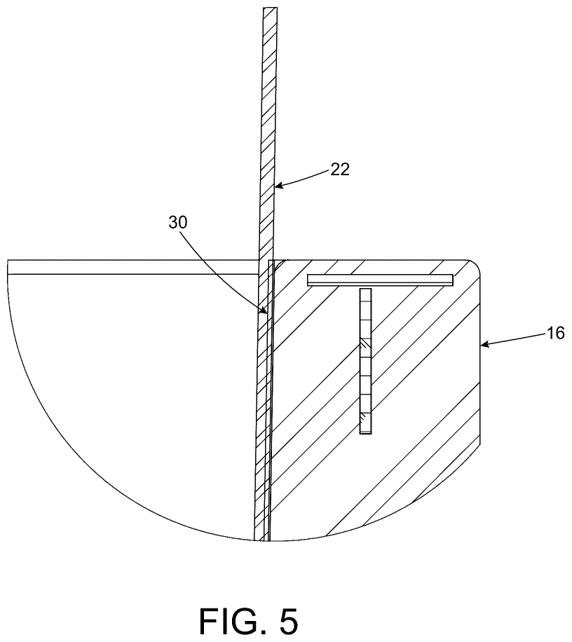

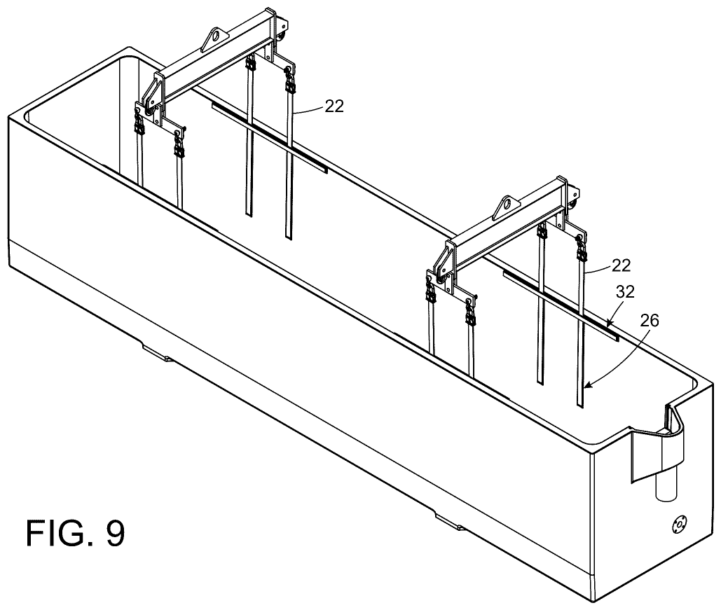

FIG. 2 show an assembly including an electrolytic vessel and an anchor system, the anchor system including two pairs of opposed single straps being provided on an inner surface of the lateral side walls of the core, whereas FIG. 4 shows an assembly including electrolytic vessel and an anchor system, the anchor system including two pairs of two opposed straps being provided on an inner surface of the lateral side walls of the core. The strength of the securing of the straps to the core wall can be further modulated by using chemical fixation only (as in FIGS. 2, 4, 5 and 6) or one or more additional strengtheners to couple the straps to the core (as in FIGS. 9, 16, 19, 21 and 23).

### Chemical Fixation

For securing the lower strap sections 26 to the surfaces of the core walls 16, various techniques can be used.

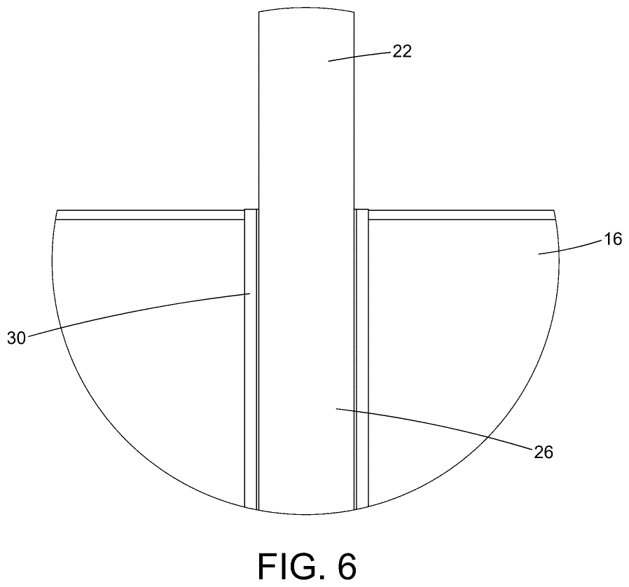

Referring to FIGS. 3 and 4, lower strap sections 26 are secured using chemical fixation 30 resulting from applying a primer for adherence and then an adhesive to a side surface of the lower strap section, applying the treated lower strap section to the core wall surface, applying pressure onto the assembly and allowing the adhesive to cure and form the chemical fixation. As exemplified in FIG. 6, a portion of the applied adhesive can spread to sides of the strap 22 upon applying pressure towards the core wall, which form excess material curing on the surrounding of the strap which make the chemical fixation 30 visible. It should be understood that the quantity of primer and adhesive can be controlled to minimize excess cured material.

Optionally, the adhesive can be air cured. Optionally, formation of the chemical fixation can include heating the adhesive to accelerate the curing process.

For example, the adhesive can be or include epoxy resin, acrylics, urethanes, silicones, or any combinations thereof (from Dow Chemical, Sika Canada, Ciba Geigy, BASF, and/or Epoxy Chemtec). For example, the primer for adherence can be or include silane, siloxane, or any combinations thereof (from Bic, Gelest, Shin-Etsu Chemical, Nitrochemie Aschau Gmbh, Silar (Entegris), Evonik Industries, Wacker Chemie AG, and/or Xiameter).

In some implementations, the portion of the core wall that is to be coupled with the strap by the chemical fixation can also be treated with the adhesive, and/or adherent primer before the treated lower strap section is applied onto the core wall.

### Anchor and Strap

The anchor system also includes a plurality of anchors connected to respective upper strap section of each strap of the anchor system. The anchors are configured to be coupled to the straps and to be further anchorable to a corresponding lifting accessory of a lifting device. It should be noted that multiples anchors can be secured to the same lifting accessory.

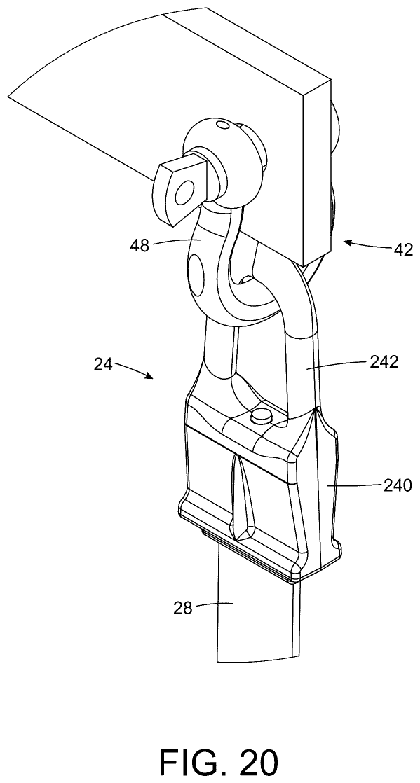

Referring to FIG. 20, the anchor 24 can be described as including a main component 240 and a connector 242. The main component 240 serves as a link between the connector 242 and the upper strap section 28, the upper strap section 28 being connected to the main component 240 and the connector 242 being connectable to the lifting accessory 42 of the lifting device (not shown).

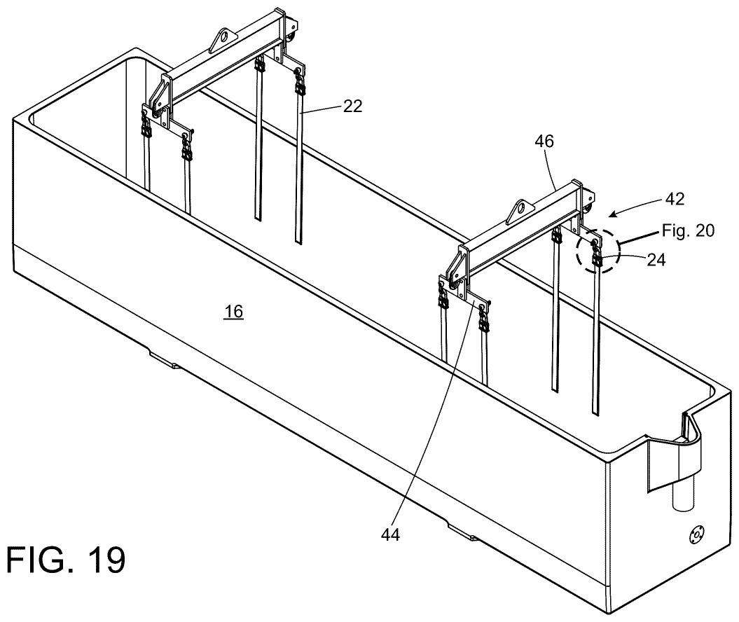

As better seen in FIG. 19, the lifting accessory 42 can have a H-structure, such that four anchors 24 can be connected to corresponding corners 44 of the lifting accessory 42, with the lifting accessory 42 comprising a central beam 46 for connection to the lifting device (not shown). Still referring to FIG. 19, the lifting accessory 42 can thus be activated to pull upward on the straps 22 of the anchor system, the straps being secured to the core wall surfaces according to techniques described herein to enable the core 16 to be raised and displaced. One skilled in the art will readily understand that the number and position of the lifting accessories can be chosen according to the size and weight of the vessel to be lifted. Preferably, a symmetrical configuration can be used to lift the vessel to avoid any unbalanced movements during lifting of the vessel.

Materials of each strap may be selected according to the strength and flexibility desired. For example, pultruded fiberglass can be used to form each strap. For example, nylon, fiberglass or polyester could be additionally used for further flexibility. The strap can be made thin to provide bendability. For example, the strap can have a thickness of at most 12 mm.

Connection of the strap with the main component can be performed according to techniques available in the art, such as described in published patent application PCT/CA2016/051189 that is incorporated herein by reference. For example, the strap can be connected to the main component by chemical fixation. More particularly, the end of the upper strap section can be inserted into a strap slot defined in the main component and chemically fixed therein, optionally using a non-corroding adhesive that may include epoxy, thermoset resin, polyester, vinyl ester, acrylic, silicone, or thermal glue. The thermal glue may include polypropylene and/or polyethylene.

Referring to FIG. 20, the anchor 24 can be secured to a connector component 48 of the lifting accessory 42. However, connection between each anchor of the anchor system and the lifting accessory can vary in accordance with available techniques in the art, without being limited to what is illustrated in the Figures. In a first implementation, connector components that are used to provide anchorage to the lifting accessory of the lifting device can include various types of hooks and bolts, such as a C-shaped hook, or a D-shaped hook (as seen in FIG. 20) It would be readily understood that the connector component may be easily adapted to the lifting accessory and anchor, without being limited to the connector components illustrated in the Figures.

It should be further noted that the main component of the anchor can have various shapes to accommodate the vessel geometry and to offer an adequate surface to support the connector of the anchor. In some implementations, referring to FIG. 20, the connector 242 of the anchor 24 can be a hook protruding from the main component 240. The main component 240 can have a substantially parallelepiped shape to serve as a base for a proximal end of the hook 242. A distal end of the hook 242 can be shaped as a C or as a D (FIG. 20) to offer anchorage to a loop such as found in a chain or the connector component 48 of the lifting accessory 42.

The anchor can be made of galvanized metal, cast iron, stainless steel and other steel alloys, copper, bronze, or aluminium-bronze. Optionally, the main component and the connector of the anchor can be made as a one-piece structure.

### Additional Strengthener(s)

In addition to the chemical fixation of the strap to the core of the vessel, various battens can be provided to enhance the strength of the connection between the lower strap sections and the core walls and to reduce the torsion of the strap during lifting and displacement. For example, an overlay batten 32 can be provided, as shown in FIG. 9, to cover a portion of at least one lower strap section 26 in a transversal direction. In addition, a length of the overlay batten 32 can be chosen to extend over and across one or more of the straps 22, as shown in FIG. 9. The anchor system can include a plurality of overlay battens maintaining the respective lower strap sections onto opposed core walls of the electrolytic vessel. The overlay battens can be non-perforated and can extend horizontally (in a transverse direction with respect to a direction of the strap).

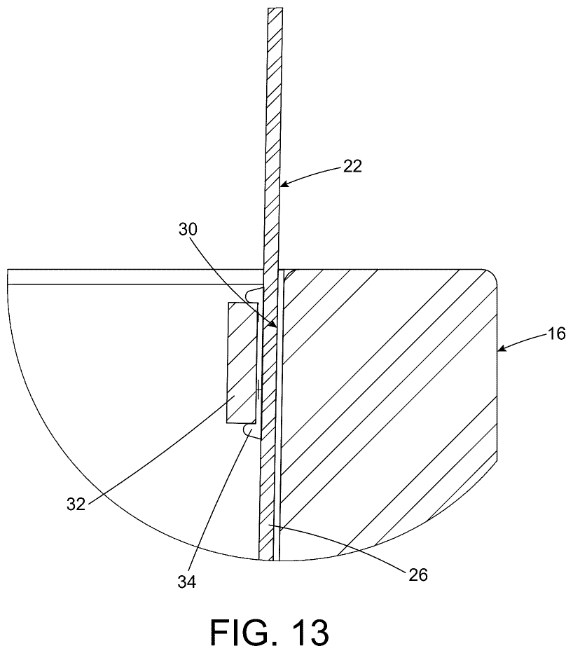

The overlay batten can be chemically fixed to the strap and/or core with a primer and an adhesive, and in accordance with the method as described above to couple the lower strap section to the core. The primer and adhesive can be the same or different as the ones used for coupling the strap to the core. As better seen in FIG. 13, the overlay batten 32 is seen coupled to a portion of an outer side surface of the lower strap section 26 of the strap 22 via chemical fixation 34, whereas the lower strap section 26 is seen coupled to the core wall via chemical fixation 30.

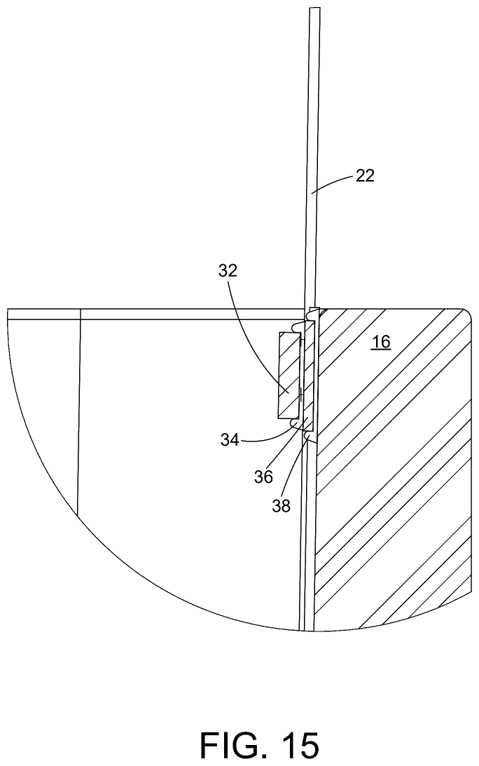

To ensure adherence of the overlay batten, several underlay batten segments can be further provided to offer an even surface and avoid any gaps between the overlay batten and the core of the vessel. For example, a central underlay batten segment can be positioned onto the core and between two adjacent straps, and another side underlay batten segment can be positioned onto the core along a side of each strap and in the same direction as the overlay batten, to provide an even surface along the underlay batten segments and straps for positioning the overlay batten extending over the two straps. FIG. 15 shows one underlay batten segment 36 positioned onto the core 16 and offering an even surface for the overlay batten 32 to rest thereon and avoid any gap that would otherwise be present between the overlay batten 32 and the core 16. The underlay batten segment 36 is for example coupled to the core with chemical fixation 38 which is similar to the chemical fixation 34 described above for coupling the overlay batten 32 to the strap 22.

The battens (overlay and underlay) can be composed of or include various materials, such as pultruded fiberglass, E-glass fibers, High-Strength (HS)-glass fibers, Kevlar fibers, synthetic fibers (e.g., nylon, polyester), carbon fibers, or combinations thereof. The material(s) for the battens can be particularly selected to have tailored dielectric properties, such as a dielectric constant ASTM D-150 of at most 5,0 at 60 Hz.

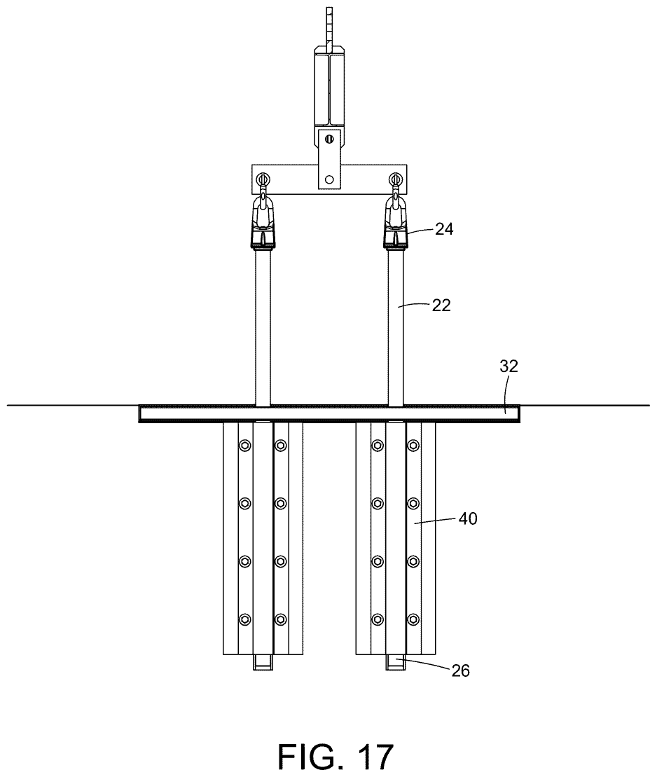

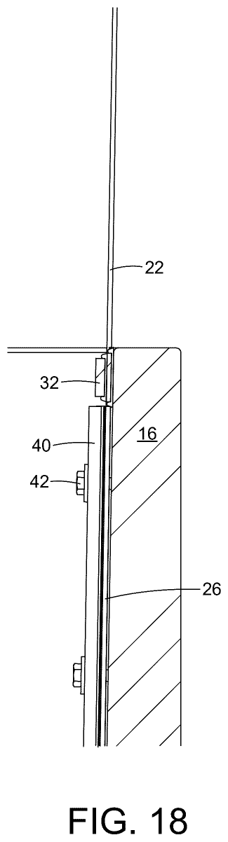

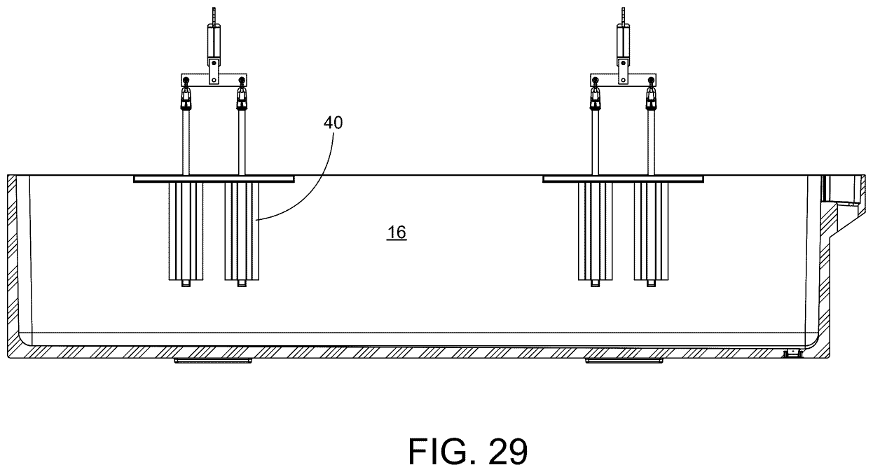

In some implementations, the anchor system can further include an additional strengthener in the form of a vertical strengthener that is positioned onto and to encase the lower strap section of each strap of the anchor system. Referring to FIG. 17, the strengthener 40 can be provided onto the lower strap section 26 in a vertical direction to encase a portion of the strap 22 and further secure it to the core wall 16. The strengthener 40 can be chemically fixed onto the core 16 as seen in FIG. 29 to 31 and/or perforated to be fastened onto the core, e.g., via fasteners 42 as seen in FIG. 18 that can include screws. It should be noted that the fasteners, when used, are provided along lateral side portions of the vertical strengthener such that the fasteners are secured to the core without having perforations through the corresponding straps 22. It should be noted that mechanical fixation refers herein to the use, for example, of fasteners to secure a component onto the respective core walls and/or lower strap sections.

In the case of the damaged electrolytic vessel, the damaged state of the vessel can be such that yet additional reinforcement may be needed to avoid crumbling of the vessel during lifting and displacement.

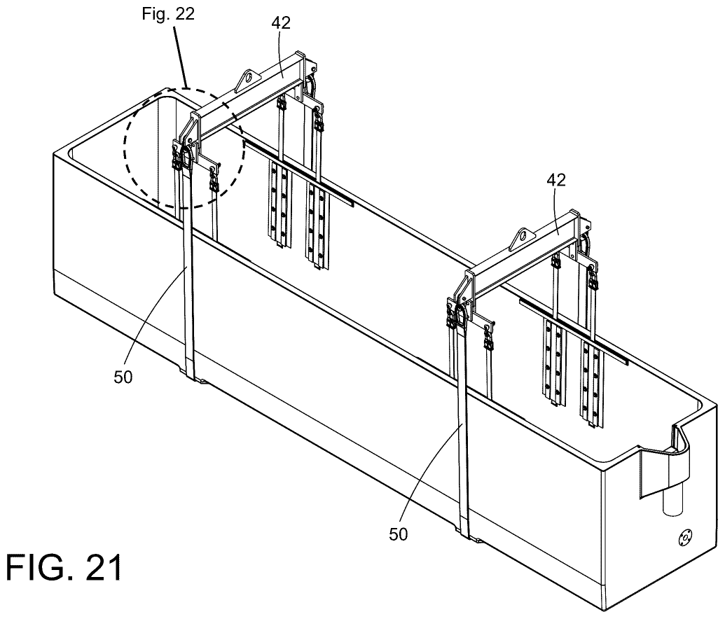

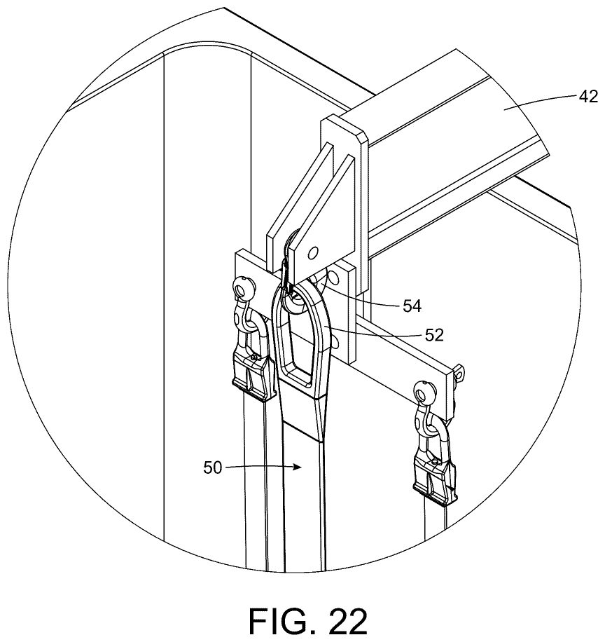

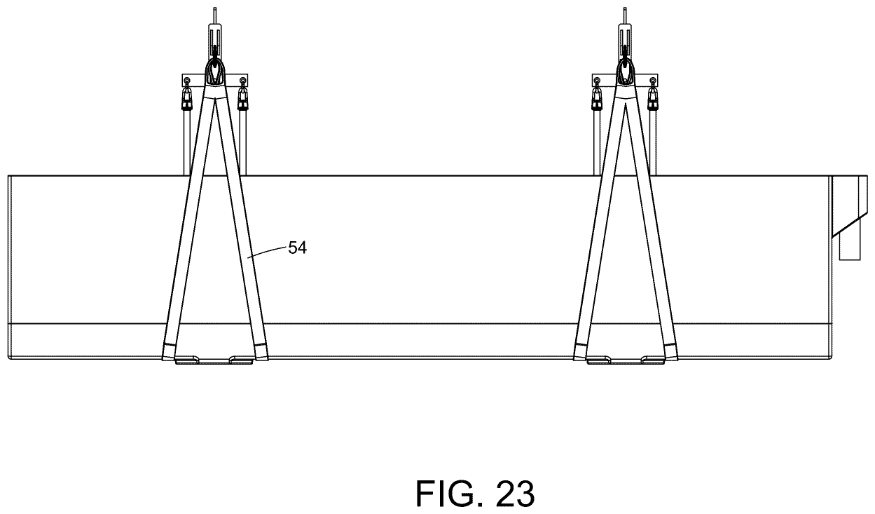

In some implementations, the anchor system can further include at least one outer strap that is positioned to surround an outer surface of the core. The strap is provided with a loop or hook component at each end thereof for securing the strap onto the lifting accessory of the lifting device. Such outer strap can be particularly needed when the electrolytic vessel is displaced over a long distance that maintain the applied mechanical constraints for a longer time than a typical short displacement. FIG. 21 shows an implementation of an anchor system further including a pair of outer straps 50 that are respectively surrounding end portions of the electrolytic vessel and that are secured to a corresponding lifting accessory 42. Referring to FIG. 22, each end of the outer strap 50 can be formed as a loop component 52 which is secured to the corresponding lifting accessory 42 with another dedicated connector component 54 of the lifting accessory 42. In some implementations, each outer strap can include two angled strap members as seen in FIG. 23.

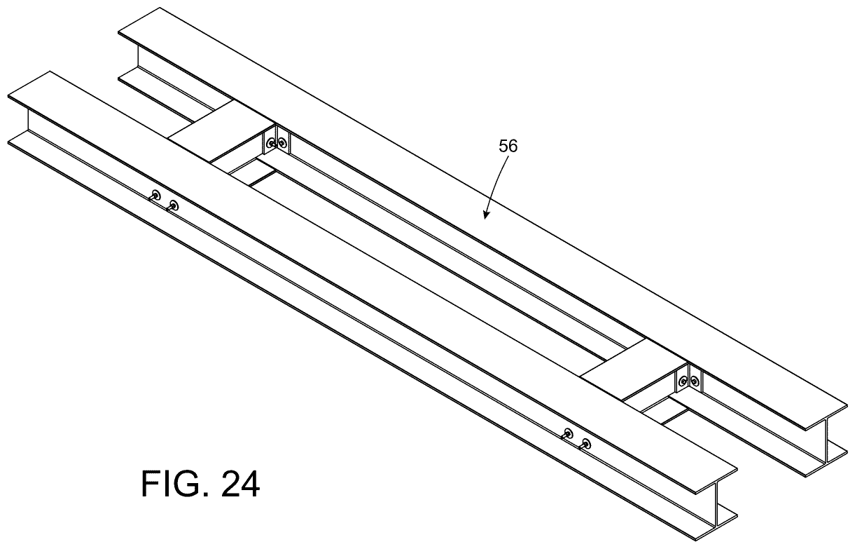

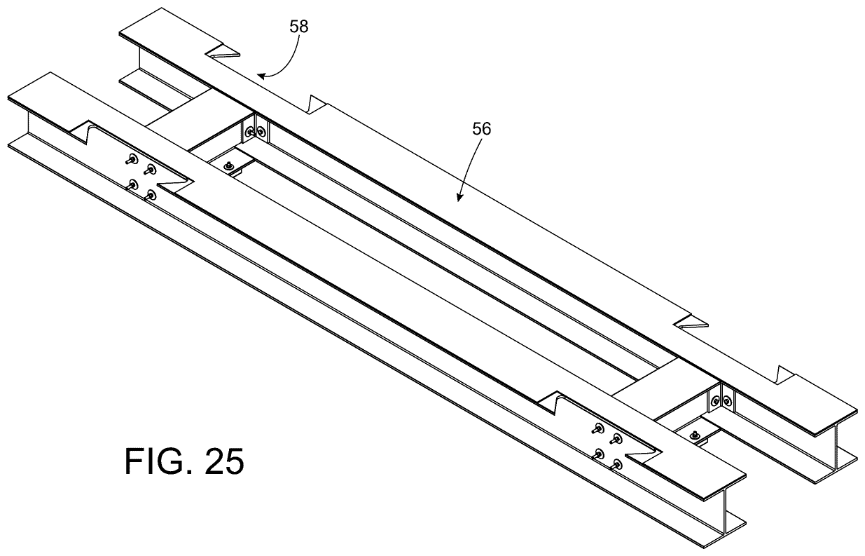

In some implementations, the anchor system can further include a strengthening base that can be provided below the vessel along the base core wall, particularly when the vessel is in an advanced state of damage. Referring to FIGS. 24 and 25, the strengthening base 56 can extend along a longitudinal direction of the electrolytic vessel and be maintained against the base core wall with the outer straps as illustrated in FIG. 21 or 23. The size and configuration of the strengthening base can vary in accordance with the design of the electrolytic vessel and the state of damage of the electrolytic vessel. For example, as seen in FIG. 23, the strengthening base 56 can include notches 58 that are sized to engage a corresponding feet of the electrolytic vessel and to reduce translation of the base with respect to the vessel during lifting and displacement.

In some implementations, the strengthening base can be made of pultruded fiberglass profile, wood stud or any Fiberglass hand layup part or made by other processes. The base can be shaped as a channel, I-beam, wide flange I-beam, rectangular tube, round tube or square tube.

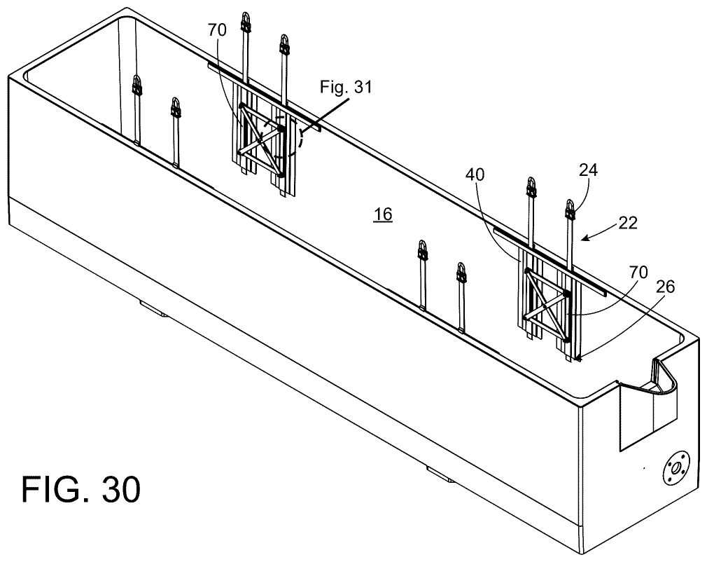

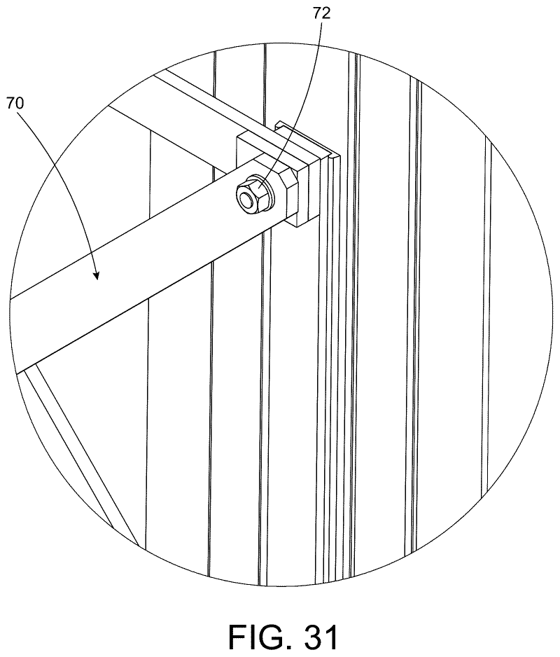

In some implementations, the anchor system can further include a connector component that is used to join two adjacent straps and provide additional securing of said straps to the core wall. For example, as seen in FIG. 30, a connector component 70 is seen secured the lower strap sections 26 of pair of adjacent straps 22 of the anchor system. The anchor system that is illustrated includes vertical strengtheners 40 that are fastened to the lower strap sections 26 and each corner of the connector component 70 is further secured to a corresponding vertical strengthener 40. The securing of the connector component 70 can be performed via chemical fixation and/or mechanical fixation, e.g., in FIG. 31, with a plurality of fasteners 72 positioned at least at each corner of the connector component and in alignment with each strap as seen in FIG. 31. The connector component is used to maintain together the strengtheners (referred as a strengthening assembly) and distribute the mechanical constraints during freight and installation of the goods.

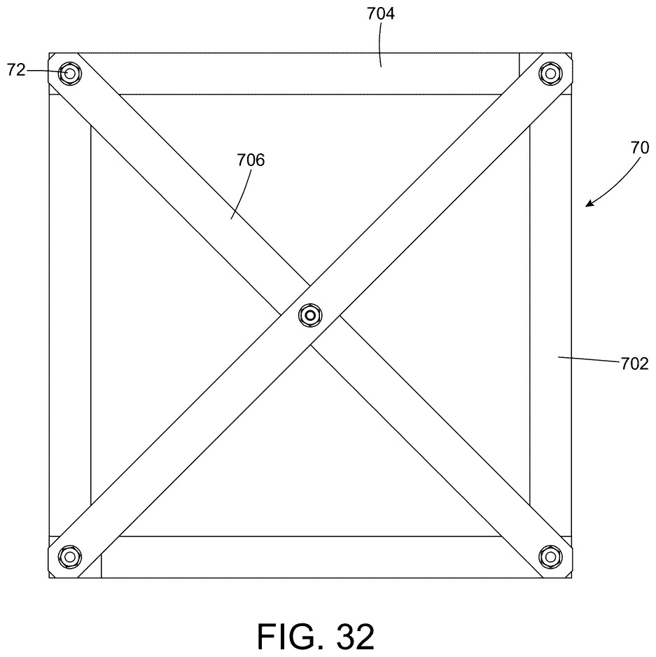

The connector component can include multiple interconnected members that are combined to join the two adjacent straps. For example, referring to FIG. 32, the connector component 70 can be a cross connector component including a pair of cross members 706 that are joined via a central fastener is a cross-like configuration. The connector component 70 can further include a pair of vertical support members 702 and a pair of horizontal support members 704 that are held together in a square-like configuration with the cross members 706 through the fasteners 72 that are positioned at each corner of the connector component 70. It should be noted that the size and configuration of the connector component is not limited to the one illustrated in the Figures. For example, the vertical members can be sized differently from the horizontal members to accommodate a space available between the two adjacent straps.

In addition, in case the damaged vessel is at risk of falling apart during displacement, the anchor system can be combined with a net that is sized and positioned to surround an exterior surface of the vessel. The net can be placed once the anchor system is coupled to the electrolytic vessel.

### Another Anchor System

In another aspect, there is provided an anchor system including a base that is secured to an inner surface of the base core wall of the electrolytic vessel and a plurality of straps that are anchored from multiple anchorage points of the base.

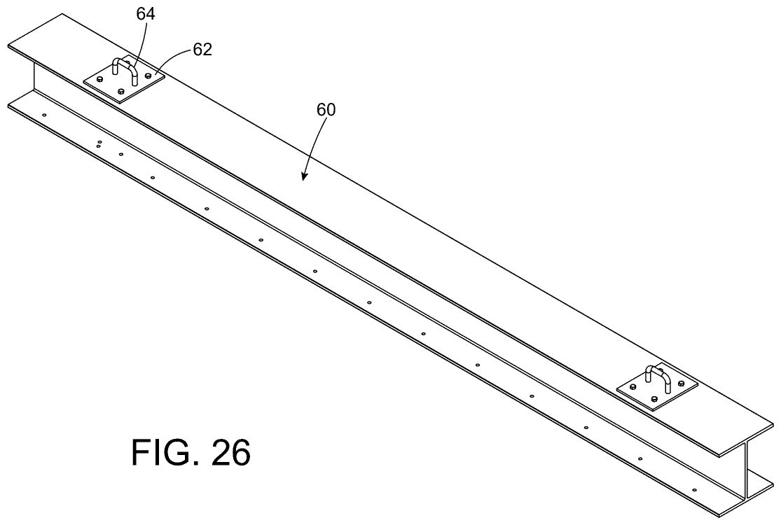

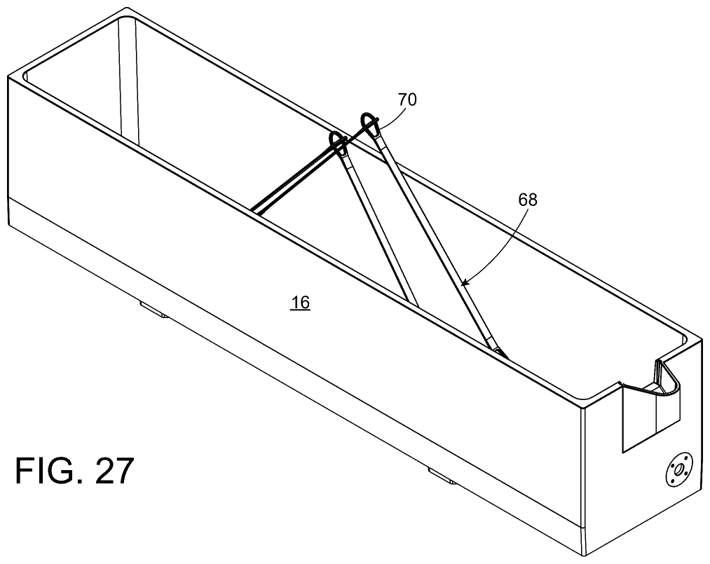

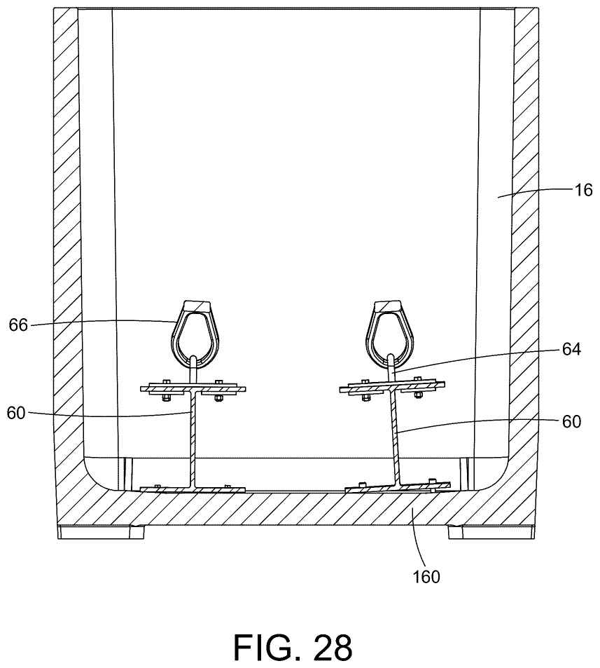

Referring to FIG. 26, a base 60 is provided as an elongated component comprising two anchorage sections 62, each including an anchor 64 for securing at least one strap (not shown). Referring to FIGS. 27 and 28, at least one base 60 as shown in FIG. 26, for example two bases 60, can be secured via fasteners to the base core wall 160 of the core 16 to provide anchorage to a distal anchor 66 provided at a distal end of each strap 68. Each strap 68 is further provided at a proximal end thereof with a proximal anchor 70 that is connectable to the lifting accessory of the lifting device (not shown in FIG. 27).

In some implementations, the base 60 can be shaped as an I-beam, a wide flange I-beam, or a rectangular/square tube offering adequate surfaces to define anchor sections including the anchors, and adequate surfaces for securing the base 60 to the bare core wall of the core 16.

In some implementations, the proximal anchor 70 can be the same as the distal anchor 66 shown in FIG. 28 or the same as the anchors 24 shown in FIG. 20, or can have another design as compatible with the lifting accessory. It is noted that the straps 68 can include features similar to the ones described in relation to the straps 22 in other Figures.

### Installation and Lifting

Various steps of the installation method are described herein in accordance with the above detailed implementations of the anchor system. Installation of the anchor system to an electrolytic vessel can be also referred to as securing the anchor system to at least two opposed walls of the core of the electrolytic vessel.

For example, the securing can include pre-treating at least the side surface of each lower strap section of the anchor system and the corresponding surfaces of the core walls. The pre-treatment can include sanding the surfaces, optionally with water addition. The pre-treatment can further include cleaning the surfaces with a solvent such as alcohol. The pre-treatment can further include letting the surfaces dry.

Referring to FIGS. 3 and 4, the securing of the anchor system further includes securing the lower strap sections 26 to the surfaces of the core walls 16, according to various techniques. For example, the lower strap sections 26 can be secured using chemical fixation 30 resulting from applying a primer for adherence and then an adhesive to a side surface of the lower strap section, applying the treated lower strap section to the core wall surface, applying pressure onto the assembly and allowing the adhesive to cure and form the chemical fixation. As exemplified in FIG. 6, a portion of the applied adhesive can spread to sides of the strap 22 upon applying pressure towards the core wall, which form excess material curing on the surrounding of the strap which make the chemical fixation 30 visible. It should be understood that the quantity of primer and adhesive can be controlled to minimize excess cured material.

In some implementations, the securing of the lower strap sections can further include treating, with the adhesive and/or adherent primer, the portion of the core wall that is to be coupled with the strap by the chemical fixation, before the treated lower strap section is applied onto the core wall.

It should be noted that the anchor system can be pre-assembled before securing the lower strap sections to the core. For example, strengtheners can be chemically fixed to the lower strap sections, and optionally the connector component can be secured to adjacent strengtheners of the anchor system, before securing the lower strap sections to the core via chemical fixation. If additional mechanical fixation is to be used, fasteners can be secured to the core (e.g. through the vertical strengtheners), once the anchor system is partially fixed (e.g. via chemical fixation only) to the core of the vessel.

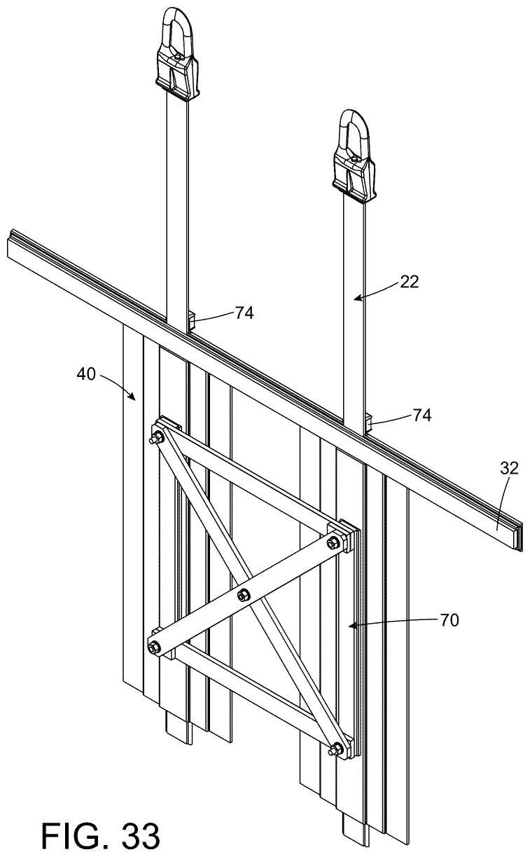

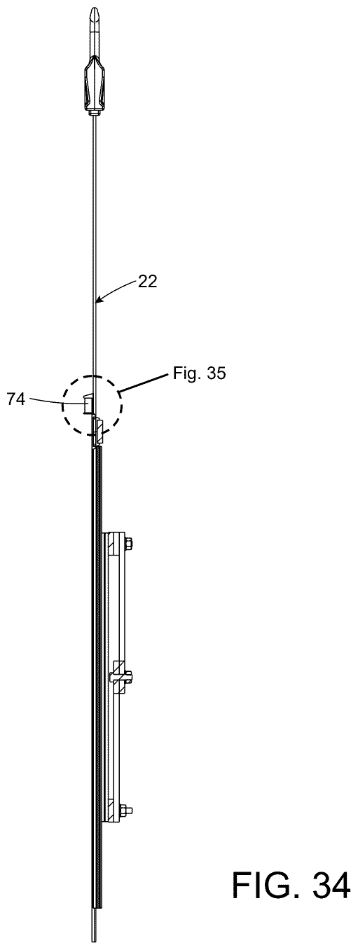

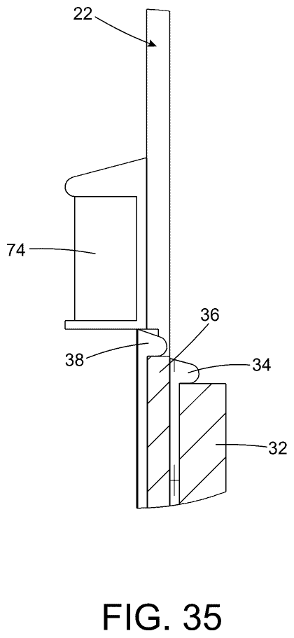

In some implementations, the method for securing the anchor system to the electrolytic vessel can include facilitating positioning of the straps onto a core wall before securing the lower strap sections. For example, referring to FIGS. 33 to 35, a mechanical stop element 74 can be secured to a back side surface of the strap 22 and above any strengtheners so as to abut a top of a corresponding core wall of the electrolytic vessel, such that the anchor system can hang along the core wall during securing of the lower strap sections, and further securing of the strengtheners if any.

There is further provided a method for lifting and displacing an electrolytic vessel, for example a damaged electrolytic vessel. The method includes securing the anchor system to the core of the electrolytic vessel as above detailed, securing the lifting accessory of the lifting device to the anchors of the anchor system; and activating the lifting device to lift the electrolytic vessel.

It should be understood that any one of the above-mentioned optional aspects of each anchor system and related techniques may be combined with any other of the aspects thereof, unless two aspects clearly cannot be combined due to their mutually exclusivity. For example, the various structural elements of the anchor system described herein and/or in the appended Figures, may be combined with any of the general electrolytic vessel description appearing herein and/or in accordance with the appended claims.

1. An anchor system for allowing an electrolytic vessel having a core shaped to hold an electrolytic liquid to be lifted by a lifting device, the anchor system comprising:
a plurality of straps comprising at least two straps being secured to respective surfaces of at least two opposed core walls of the core of the electrolytic vessel,
wherein each strap of the plurality of straps comprises:
a lower strap section coupled to the surface of the core wall; and
an upper strap section extending above the core; and
a plurality of anchors comprising at least two anchors configured to provide anchorage to a lifting accessory of the lifting device,
wherein each anchor of the plurality of anchors is connected to the upper strap section of the respective straps.

2. The anchor system of claim 1, wherein the lower strap sections of the plurality of straps are coupled to an inner surface of the respective opposed core walls.

3. The anchor system of claim 1, wherein the lower strap sections of the plurality of straps are coupled to an outer surface of the respective opposed core walls.

4. The anchor system of claim 1, wherein a portion of the plurality of straps is coupled to an inner surface of the respective opposed core walls and another portion of the plurality of straps is coupled to an outer surface of the respective opposed core walls.

5. (canceled)

6. (canceled)

7. The anchor system of claim 1, further comprising a layer of chemical fixation securing each one of the plurality of straps to the surface of the respective opposed core walls.

8. The anchor system of claim 1, wherein the straps are coupled to opposed end core walls.

9. The anchor system of claim 1, wherein the straps are coupled to opposed lateral side core walls.

10. The anchor system of claim 1, wherein the layer of chemical fixation comprises an adhesive sub-layer.

11. (canceled)

12. (canceled)

13. The anchor system of claim 10, wherein the layer of chemical fixation comprises another sub-layer of adherent primer between the respective lower strap sections and the adhesive sub-layer.

14. (canceled)

15. The anchor system of claim 1, wherein each anchor comprises a main component connected to respective upper strap sections of the straps and a connector connected to the lifting accessory of the lifting device.

16. The anchor system of claim 15, wherein each anchor is selected among the group consisting of a D-hook, a 90°D-hook, a C-hook, and a T-hook.

17. The anchor system of claim 1, further comprising a plurality of overlay battens comprising at least two overlay battens being secured to respective opposed core walls and covering at least a portion of respective lower strap sections in a transverse direction with respect to a direction of the straps.

18. The anchor system of claim 17, wherein the overlay battens are chemically fixed to at least one of the respective straps or core walls.

19. The anchor system of claim 17, wherein each overlay batten is secured to a portion of an outer side surface of the lower strap section of the respective straps and a corresponding portion of the respective core walls via chemical fixation.

20. The anchor system of claim 17, wherein each overlay batten is sized to extend over and across at least two lower strap sections of adjacent straps.

21. The anchor system of claim 17, further comprising a plurality of underlay batten segments being secured to the respective core walls, the underlay batten being positioned below at least one overlay batten and in alignment with the overlay batten, with the at least one overlay batten being secured to the respective underlay batten segments.

22. The anchor system of claim 1, further comprising at least one additional strengthener being positioned onto respective lower strap sections of the straps, wherein the at least one additional strengthener comprises at least one of:
a vertical strengthener extending over the lower strap section of the respective straps and being secured to at least one of the respective core walls or the lower strap sections;
a connector component for joining two adjacent straps, the connector component defining a structure having four corners and each corner being secured to corresponding portions of respective lower strap sections of the two adjacent straps;
an outer strap that is securable to the lifting accessory of the lifting device, and that is positioned to surround an outer surface of the core of the electrolytic vessel; or
an elongated strengthening base that is held below the electrolytic vessel with the surrounding outer strap.

23. (canceled)

24. The anchor system of claim 22, wherein each vertical strengthener is at least one of chemically fixed or mechanically fixed to at least one of the respective core walls or lower strap sections.

25. (canceled)

26. (canceled)

27. (canceled)

28. (canceled)

29. A lifting system for lifting an electrolytic vessel upon actuation of a lifting device, the electrolytic vessel comprising core shaped to hold an electrolytic liquid and which comprises a core base and four core walls extending upwardly from peripheral edges of the core base, the lifting system comprising:
an anchor system as defined in claim 1; and
a lifting device coupled to the lifting accessory that is connectable to the anchor system and configured to lift the core via the anchor system.

30. The lifting system of claim 29, further comprising a net surrounding an outer surface of the electrolytic vessel to hold the electrolytic vessel during lifting thereof, with the net being securable to the lifting accessory.

31. (canceled)

32. (canceled)
